(19) United States
(12) Patent Application Publication
(10) Pub. No.: US 2016/0186883 A1
(43) Pub. Date: Jun. 30, 2016

(54) VALVE HAVING A LINEAR DRIVE FOR THE VALVE PISTON

(71) Applicant: PARKER HANNIFIN MANUFACTURING GERMANY GMBH & CO. KG, Bielefeld (DE)

(72) Inventor: Hartmuth Rausch, Korschenbroich (DE)

(21) Appl. No.: 14/909,257

(22) PCT Filed: Jul. 30, 2014
(86) PCT No.: PCT/EP2014/066363

§ 371 Date: Feb. 1, 2016

(30) Foreign Application Priority Data
Jul. 30, 2013 (DE) 10 2013 108 164.9

(51) Int. Cl. F16K 31/08; H02K 41/03; F16K 31/06

(52) U.S. Cl. CPC F16K 31/082; F16K 31/0679; H02K 41/031

(57) ABSTRACT

A valve having a valve piston (13) which can be moved linearly in a valve housing (10) and a linear drive (20) which comprises a stator (21) which is connected immovably to the valve housing (10) and a rotor (22) which can be moved therein and loads the valve piston (13), is characterized in that, if a coil (23) is embedded in the stator housing, in each case one outer web (25) is arranged on the outer sides thereof or, if a plurality of coils (23) are embedded in the stator housing, in each case one inner web (24) is arranged between the coils (23) and in each case one associated outer web (25) is arranged on the outer sides of the outermost coils (23), wherein the axial extents of inner webs (24) and outer webs (25), permanent magnets (26) and pole pieces (27) are adapted to one another in such a way that, in order to configure a force increase which is active when the at least one pole (23) is energized, at least one corner (A, B) (C, D) of a pole piece (27) on one side and at least one corner (A′, B′) (C′, D′) of an outer web (25) on the other side lie opposite one another in the stroke region of the valve piston (13) in such a way that, at this point in the air gap (28), the magnetic fields of permanent magnet (26) and energized coil (23) are rectified and concentrated.

The invention pertains to a valve with a valve piston that can be moved linearly in a valve housing and a linear drive comprising a stator, which is immovably connected to the valve housing, and a rotor, which can be moved therein and acts upon the valve piston, wherein the stator is composed of a housing consisting of magnetically conductive material and at least one coil arranged therein, and wherein the rotor, which is separated from the stator by an air gap, consists of at least one permanent magnet with pole pieces that consist of magnetically conductive material and border on the respective pole of the permanent magnet.

A valve with the aforementioned features, which is driven by means of a linear drive, is described in DE 693 25 669 T2; with respect to the design of this linear drive, it is merely mentioned that it consists of a stator, which is connected to the valve housing by means of a permanent and rigid mechanical connection, and a rotor, which is arranged in a rotor chamber of the linear drive, mechanically coupled to the valve piston and separated from the stator by an air gap. If the known valve is realized in the form of a directional control valve with a valve piston that can be moved in both directions, a set of windings should be provided in the stator in order to cover both moving directions. According to a preferred design, the stator and the rotor should have the same length. No further detailed information with respect to the design of the stator and the rotor of the linear drive is provided in DE 693 25 669 T2.

A conventional design of a linear motor is insofar known from DE 11 2007 001 702 T5. In this case, the stator consists of a housing made of a magnetically conductive material, in which a sequence of abutting coils is arranged. The assigned rotor consists of multiple permanent magnets, which are arranged in a row and have alternately changing polarities, such that respectively identical magnetic poles face one another, wherein pole pieces consisting of a magnetically conductive material are respectively arranged between said magnetic poles and an outer pole piece respectively forms the end of the rotor.

In valves used in fluid technology applications, i.e. particularly in hydraulic and compressed-air applications, one generally encounters the problem that flow forces, which possibly may have to be overcome in addition to the restoring spring forces acting upon the valve piston, occur in dependence on the respective stroke of the valve piston, particularly when the valve piston is moved into the open position of the valve. Depending on the design of the valve, a corresponding increase of the flow forces occurs in this case during the stroke of the valve piston. It is therefore necessary to overcome this force counteracting the motion of the valve piston with a sufficient power reserve and a sufficiently high dynamic of the valve piston motion. In contrast, no high force is required for the return of the valve piston into its closed position because the flow force acts in an intensifying fashion in this case. Although direct drives for adjusting the valve piston in valves of this type have already been disclosed, for example, in DE 693 25 669 T2, these direct drives for the valve piston are mainly limited to smaller valves and valves with a larger design typically have to be operated with a pilot control featuring a smaller, directly driven valve.

Although DE 693 25 669 T2 describes a valve that is directly driven with a linear drive, the known valve is merely intended, in particular, for keeping the fluid, which is also present in the rotor chamber, free of magnetic foreign matter by retaining potentially present magnetic foreign matter in the rotor bore due to the magnetic force of the rotor. Consequently, the cited publication contains no references to designing the linear drive with consideration of the force progression occurring during the operation of the valve.

The invention therefore is based on the objective of making available a valve with the initially cited features, in which a direct drive can on the one hand be realized regardless of the size of the valve and the dynamic of valves directly driven by means of a linear drive is on the other hand improved.

This objective is attained with the content of the claims that follow this description and also disclose advantageous embodiments and enhancements of the invention.

The invention is based on the fundamental idea that, if a coil is embedded in the stator housing, an outer web is respectively arranged on their outer sides or, if multiple coils are embedded in the stator housing, an inner web is respectively arranged between the coils and an associated outer web is respectively arranged on the outer sides of the outermost coils, wherein the axial extents of inner webs and outer webs, permanent magnets and pole pieces are adapted to one another in such a way that, in order to realize an effective force increase when at least one coil is energized, at least one corner of a pole piece on the one hand and at least one corner of an outer web on the other hand lie opposite of one another in the stroke region of the valve piston in such a way that the magnetic fields of the permanent magnet and the energized coil are rectified and concentrated at this point in the air gap.

This fundamental idea is based on the consideration that forces acting upon the rotor in its moving direction are in a linear drive essentially generated at the material transitions in the air gap, namely in the form of iron/air gap/iron. The higher the magnetic flux density at the corresponding location in the air gap, the higher the forces generated by the linear drive. The magnetic flux density is composed of the contribution of the permanent magnet and the contribution of the energized coil or coils. In this case, the highest flux densities and therefore the desired force increases naturally occur in the air gap at the locations, at which the flow directions of the permanent magnet and the coil current are rectified and the iron parts of the stator and the rotor at the same time lie opposite of one another in the air gap with a relatively small transition surface. This positioning opposite of one another can also be described in that the edges of webs and pole pieces, which participate in the formation of the corresponding corner and face the air gap, just begin to overlap one another transverse to the moving direction of the rotor. If a decisive force increase occurs in such a position of the rotor relative to the stator, a corresponding force maximum does not necessarily have to exactly coincide with this geometric point because material-specific and manufacturing-specific circumstances are also influencing factors in this respect.

In the inventive design of the stator and the rotor, the rotor reaches intermediate positions, in which corners of pole pieces and corners of webs formed in the stator also lie opposite of one another with edges that are respectively aligned with one another. However, such positions of the rotor relative to the stator do not contribute anything to a force increase as long as both aforementioned prerequisites, namely the rectification of the flow directions in the permanent magnet and the coil and the opposite positioning of assigned corners of pole pieces and inner and outer webs, are not simultaneously fulfilled. In such constellations, the flow directions in the permanent magnet and the coil may either extend opposite to one another or large-surface iron parts of the rotor and the stator lie opposite of one another.

In its simplest implementation, the inventive idea can be realized, for example, in that a rotor featuring a permanent magnet with respectively outer pole pieces is in its starting position assigned to the coil with its outer webs arranged in the stator in such a way that the outer corner of the pole piece positioned in the direction of a working stroke of the valve lies in the starting position of the rotor defined by the deenergized coil opposite of the coil-side corner of the outer web of the stator positioned toward the direction of the working stroke such that a force increase occurs when the coil is energized with a field that is rectified referred to the field of the permanent magnet due to the immediately occurring concentration of the magnetic fields of the permanent magnet and the energized coil and the force of the linear drive acting upon the valve piston from the starting position of the rotor in the direction of the working stroke is thereby immediately increased.

Particularly in valves with a short stroke, such a force increase already suffices for moving the valve piston in the direction of a working stroke with the required dynamic. However, a corresponding design of the coil and the associated webs and of the permanent magnet and the associated pole pieces, as well as a corresponding choice of the intensity of the applied current, also makes it possible to realize a sufficient force increase for larger valves.

In advantageous embodiments of the invention with a different design, an arrangement of two or more coils is proposed, wherein an inner web is respectively arranged between the coils and the associated outer web is respectively arranged on the outer sides of the outermost coils. With respect to the function of the linear drive, it is in this case decisive that the coils are either wound in opposite directions if they are acted upon with the same current or that the coils are wound in the same direction if one coil is acted upon with a positive current and the other coil is acted upon with a negative current.

In such a basic design of the stator and the rotor with a larger number of coils and permanent magnets, the axial extents, i.e. the extents in the direction of the valve piston motion or rotor motion, of the permanent magnets and the pole pieces on the one hand and of outer and inner webs and therefore the coils arranged in the stator housing on the other hand may be realized differently, namely among one another as well as relative to one another.

In a first embodiment of the invention, it is therefore proposed that two coils with an inner web arranged between the coils and outer webs arranged on the respective outer sides of the coils are provided in the stator.

In this case, it would be conceivable, for example, that the axial extent of two coils and the inner web of the stator is identical to the axial extent of the rotor with a permanent magnet and two pole pieces, wherein the axial extent of the inner web of the stator either corresponds to the axial extent of the permanent magnet of the rotor such that two force increases, which simultaneously act upon the motion of the rotor and are therefore added to one another, are realized in the starting position of the rotor or the axial extent of the inner web of the stator is smaller than the axial extent of the permanent magnet of the rotor such that the first force increase is realized in the starting position of the rotor and a second force increase is realized after a predefined valve stroke has been reached.

Alternatively to the above-described exemplary embodiments, it would also be conceivable that the axial extent of two coils and the inner web of the stator is greater than the extent of the rotor with a permanent magnet and two pole pieces, wherein the distance of the edges of the outer webs of the stator bordering on the coils from the starting position of the rotor corresponds to the valve stroke, which is adapted to reaching a position of the valve piston that in turn is adapted to the progression of the flow forces, and wherein the axial extent of the inner web of the stator is once again identical to the axial extent of the permanent magnet of the rotor such that a first force increase is realized in the starting position of the rotor and a second force increase is realized after the predefined valve stroke has been reached, or wherein the axial extent of the inner web of the stator is smaller than the axial extent of the permanent magnet of the rotor such that a first force increase is realized after an initial valve stroke has been reached and a second force increase is realized after the predefined valve stroke has been reached.

It would furthermore be conceivable that the rotor is composed of at least two permanent magnets and at least three pole pieces, wherein a coil is assigned to at least one pole piece of the rotor in the stator. All in all, such a design may by all means comprise a larger (arbitrary) number of permanent magnets and associated pole pieces, wherein a pole piece is respectively arranged on the outer ends of the rotor structure. In this case, only one coil may be assigned to at least one pole piece of the rotor in the stator. Depending on the desired force-stroke characteristic of the valve piston motion, however, it would also be possible to respectively assign several coils to individual pole pieces of the rotor.

In an applicable simple exemplary embodiment of the invention with a rotor featuring several permanent magnets and several pole pieces, a coil may only be assigned to the central pole piece.

The inventive idea can also be applied to embodiments, for example, in which the stator features three coils with two inner webs arranged between said coils and two outer webs and in which the rotor is composed of a stack of at least three permanent magnets and pole pieces that are alternately arranged between the permanent magnets and on their outer sides, wherein at least one corner of a pole piece on the one hand and a corner of an inner web and/or an outer web on the other hand respectively lie opposite of one another either in the starting position of the rotor or when a predefined valve stroke is reached in order to realize an effective force increase when the coils are energized.

In this context, the inner webs and the outer webs of the stator may respectively have an identical axial extent and the pole pieces of the rotor may have axial extents that differ from one another, wherein the two outer pole pieces respectively have a smaller axial extent than the pole piece situated between the permanent magnets. Alternatively, the inner webs and the outer webs of the stator may respectively have a different axial extent and the outer pole pieces of the rotor may have an identical axial extent corresponding to half the axial extent of the pole piece situated between the permanent magnets.

In both above-described instances, the coils arranged in the stator may either have identical or different lengths.

In the implementation of the invention, it would generally be conceivable that the distances between the webs arranged in the stator are respectively identical to one another and the axial extents of the pole pieces in the rotor differ from one another or that the distances between the webs arranged in the stator differ from one another and the axial extents of all pole pieces in the rotor are respectively identical. Accordingly, the distances between the webs arranged in the stator may differ from one another and the axial extents of the pole pieces in the rotor may differ among one another or the distances between the webs arranged in the stator, as well as the axial extents of the pole pieces in the rotor, are respectively identical to one another.

If the invention is applied to directional control valves with a valve piston acting in both stroke directions of the valve, one prerequisite for this function is a symmetric design of the rotor and the stator referred to the axis of symmetry extending perpendicular to the moving direction of the rotor such that corresponding force increases are respectively realized in both moving directions of the rotor and of the valve piston driven thereby.

However, the invention can also be applied to valves realized in the form of plug-in valves with a valve piston acting in one stroke direction only. Since a corresponding force increase or force maximum only needs to be realized in one moving direction of the valve piston in this case, it is proposed that the rotor and the stator have an asymmetric design referred to the axis of symmetry extending perpendicular to the moving direction of the rotor.

If the force increase for the movement of the valve piston requires very high actuating forces, it would ultimately be conceivable to arrange several linear drives, which respectively consist of a stator and a rotor, parallel to one another in the moving direction of the valve piston, wherein the rotors of the linear drives are respectively connected to the valve piston.

An inventive linear drive can be used in connection with all conventional valve types; in this respect, the detailed internal design of the hydraulic valve is not important as long as the rotor of the linear drive is respectively connected to the valve piston of the hydraulic valve. Since the function of the inventive linear drive is respectively adapted to a starting position of the rotor and therefore of the valve piston, in which the at least one coil of the linear drive is energized in order to realize a working stroke of the valve piston, this starting position may, according to an exemplary embodiment of the invention, be realized by automatically adjusting the position of the valve piston in the deenergized state of the linear drive. In accordance with the corresponding prior art, the valve piston may for this purpose be held in the starting position, which corresponds to a central position, by means of springs acting upon the valve piston on both sides as it is common practice with directional control valves. However, other starting positions for the valve piston would also be conceivable, for example, in 2/2 directional control valves (e.g. cartridge valves), in which the valve piston is respectively displaced between two end positions only.

According to exemplary embodiments of the invention, the starting position of the valve piston adjusted, in particular, in the deenergized state of the linear drive may correspond to the closed position of the valve or, alternatively, to a working position of the valve piston, in which connections between valve housing ports are maintained open.

Exemplary embodiments of the invention are illustrated in the drawings and described in greater detail below. In these drawings:

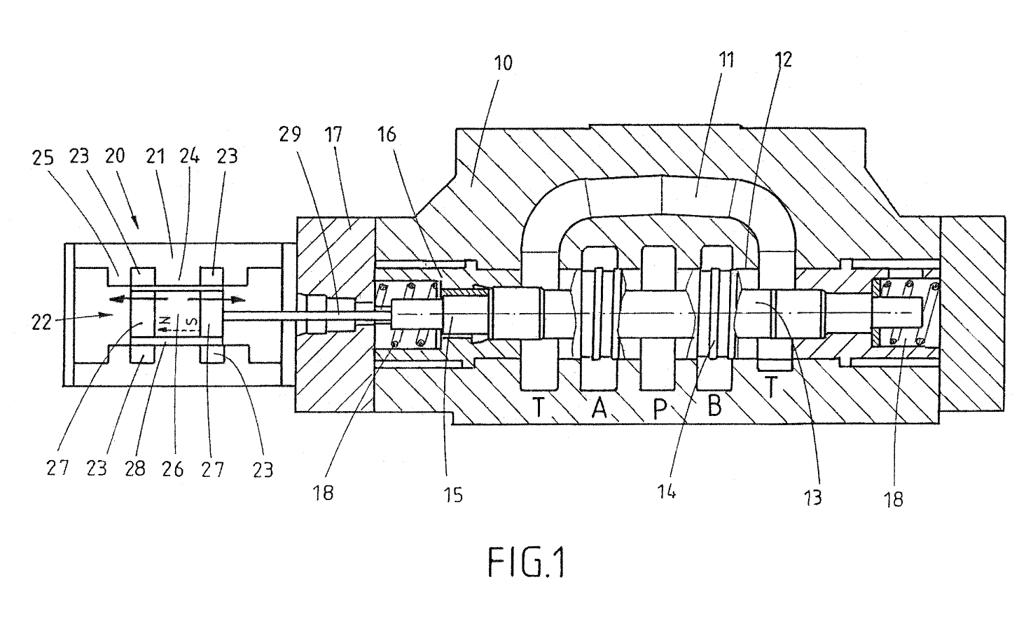

FIG. 1 shows a hydraulic valve realized in the form of a directional control valve, as well as a linear drive for its valve piston, in the form of a schematic, sectioned side view,

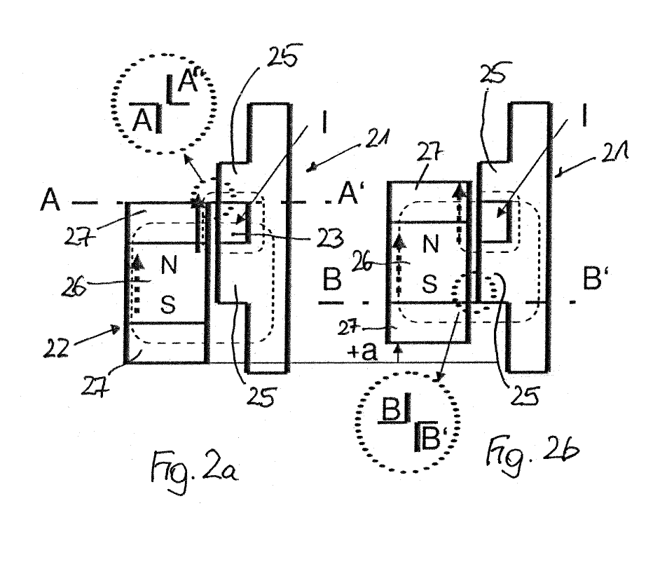

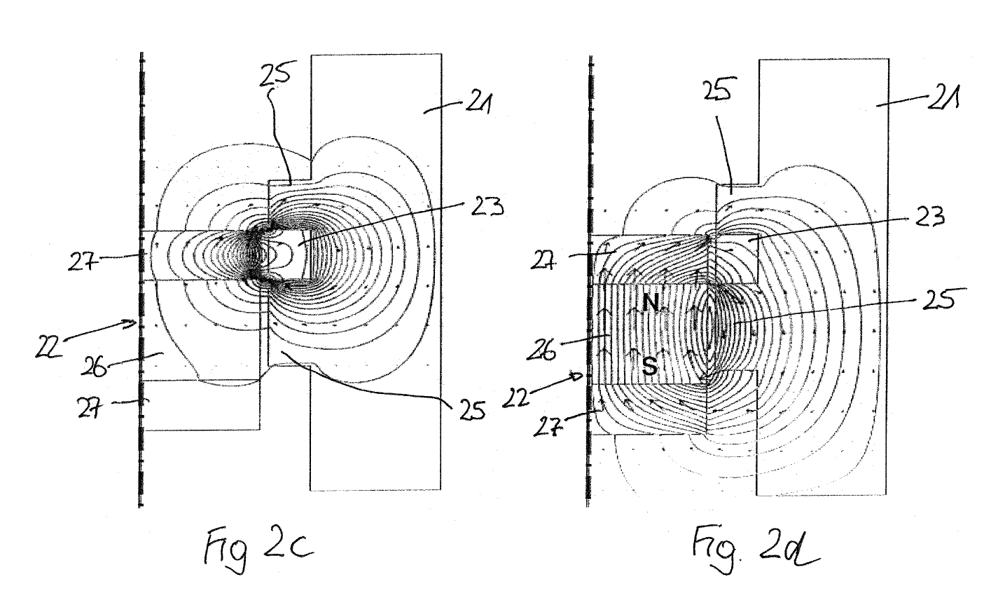

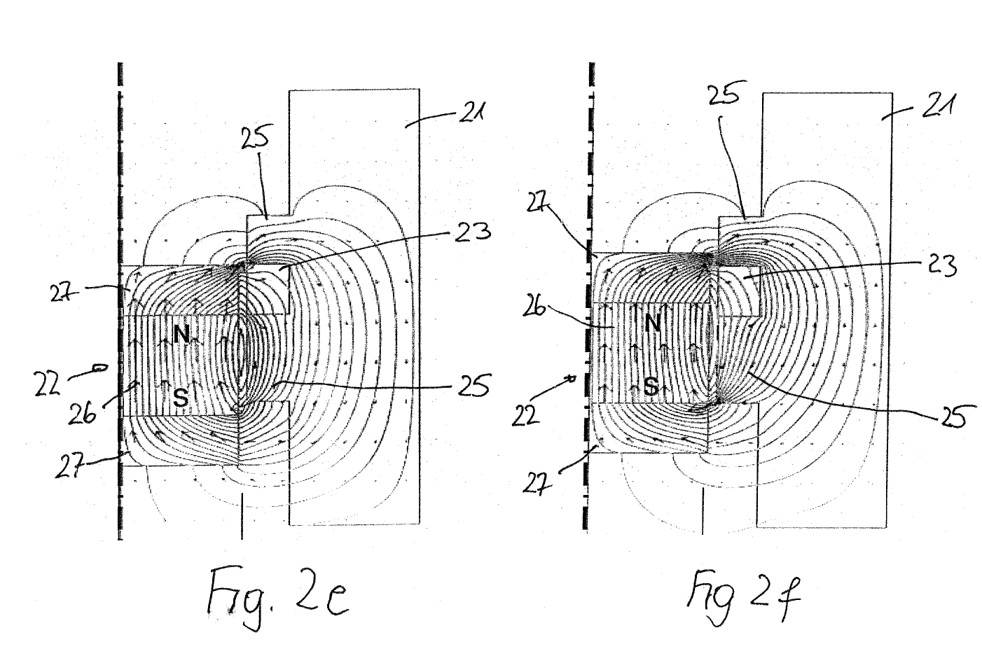

FIG. 2a shows a first exemplary embodiment of the linear drive with a stator that features a coil with two outer webs, as well as a rotor that is composed of a permanent magnet and two adjacent pole pieces, in the form of a schematic illustration in the starting position of the rotor,

FIG. 2b shows the object of FIG. 2a after carrying out a rotor-side stroke “a,”

FIGS. 2c-e show the formation of the field lines in the exemplary embodiment illustrated in FIG. 2a, with

FIG. 2c showing the field lines originating from the energized coil without consideration of the field generated by the permanent magnet,

FIG. 2d showing the field lines originating from the permanent magnet without consideration of a field generated by the coil current and

FIG. 2e showing the superimposed field lines of the permanent magnet and the coil current,

FIG. 2f shows the formation of the field lines in the position of the rotor illustrated in FIG. 2b,

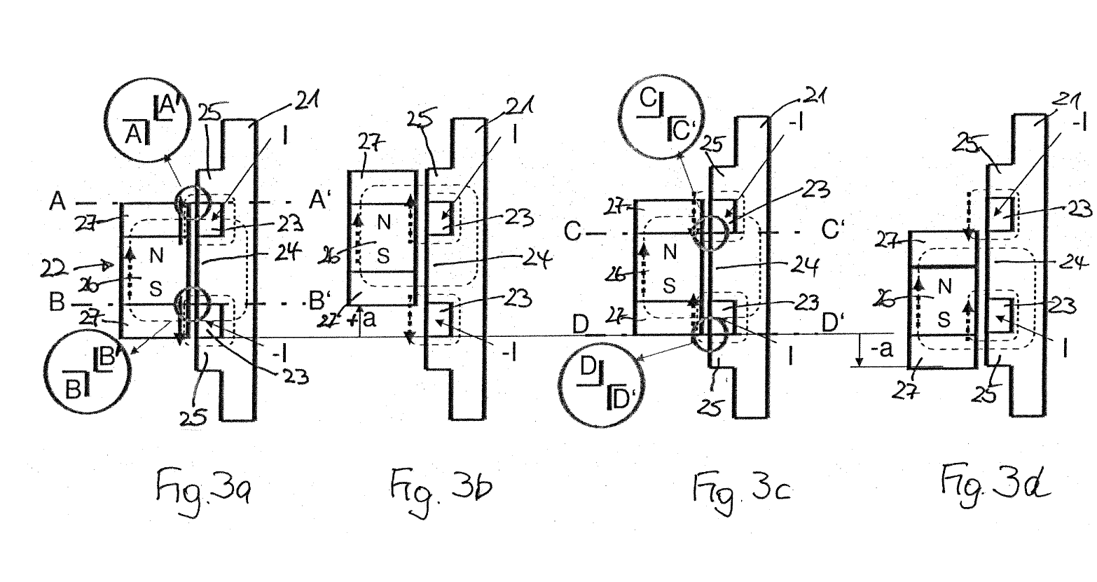

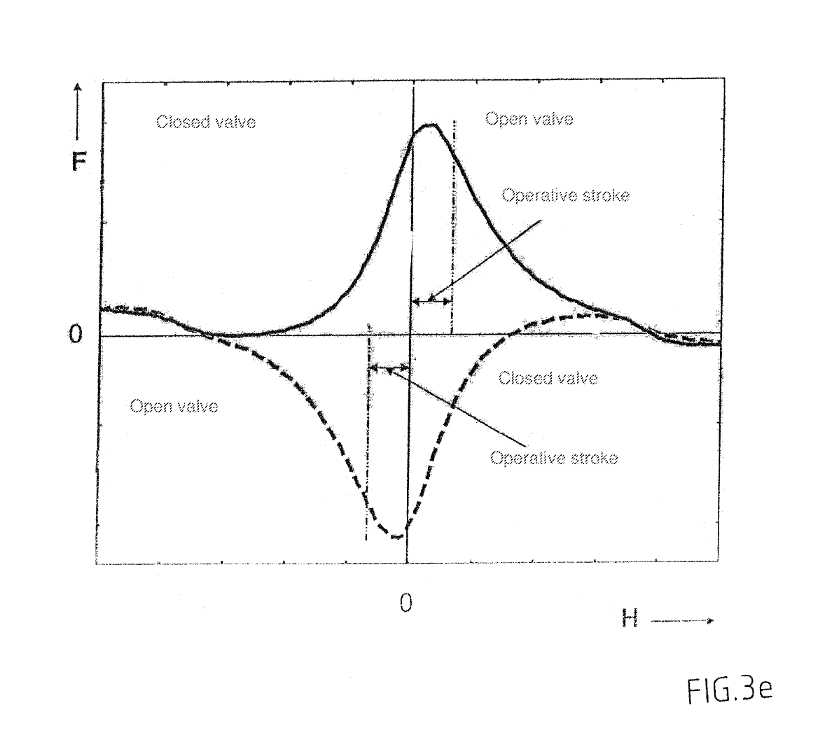

FIG. 3 shows another exemplary embodiment of a symmetrically designed linear drive with two coils, a stator comprising an inner web and two outer webs, as well as a rotor that is composed of a permanent magnet and two adjacent pole pieces, namely in the form of an illustration corresponding to FIGS. 2a, b, with

FIG. 3a showing rotor in its starting position,

FIG. 3b showing the position of the rotor after reaching a stroke “+a” in one moving direction of the rotor,

FIG. 3c once again showing the rotor in its starting position subsequent to the return stroke,

FIG. 3d showing the position of the rotor after reaching a stroke “−a” in the other moving direction of the rotor and

FIG. 3e showing a force-stroke diagram for a force progression occurring in a linear drive according to FIGS. 3a-d,

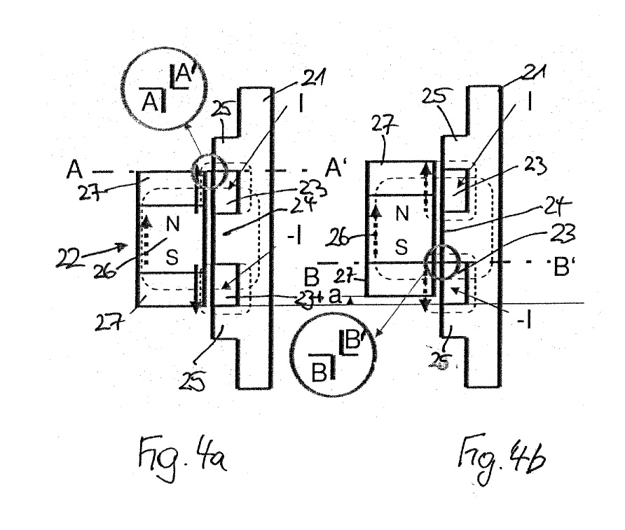

FIGS. 4a-c show another exemplary embodiment of the linear drive in the form of illustrations corresponding to FIGS. 3a, b and e,

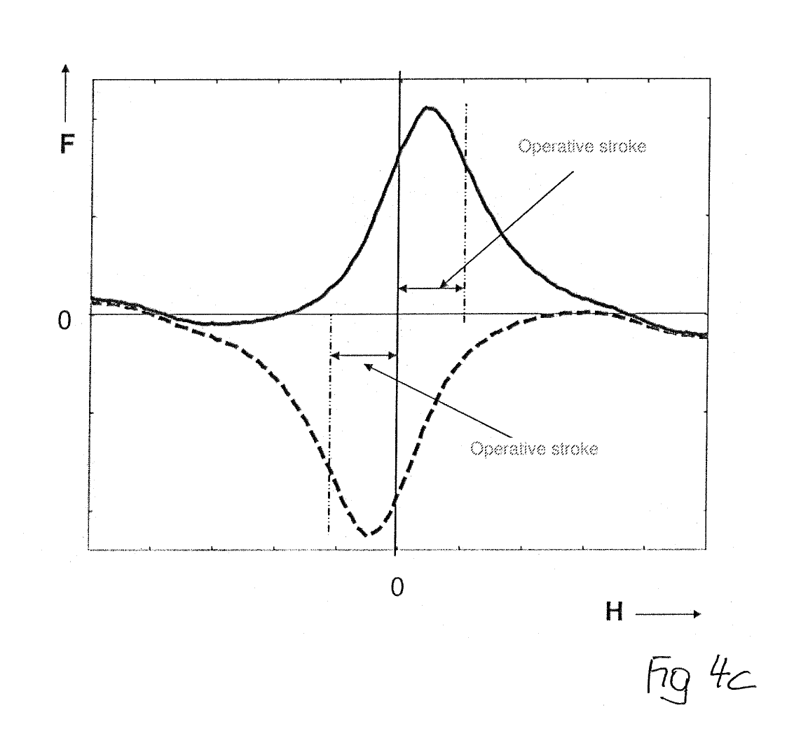

FIGS. 5a-e show another exemplary embodiment of the linear drive in the form of illustrations corresponding to FIGS. 3a-e,

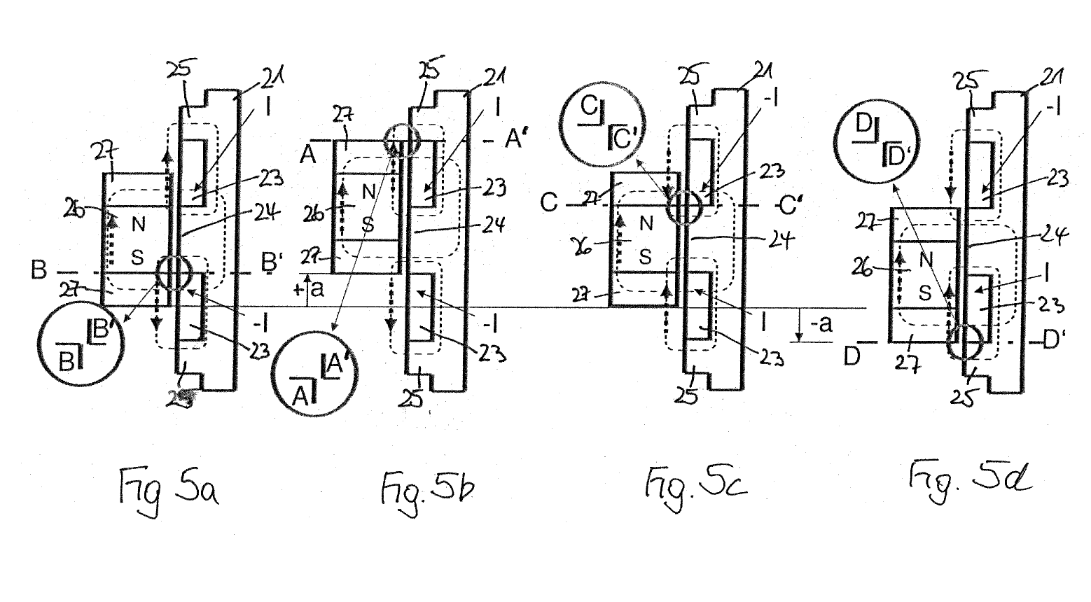

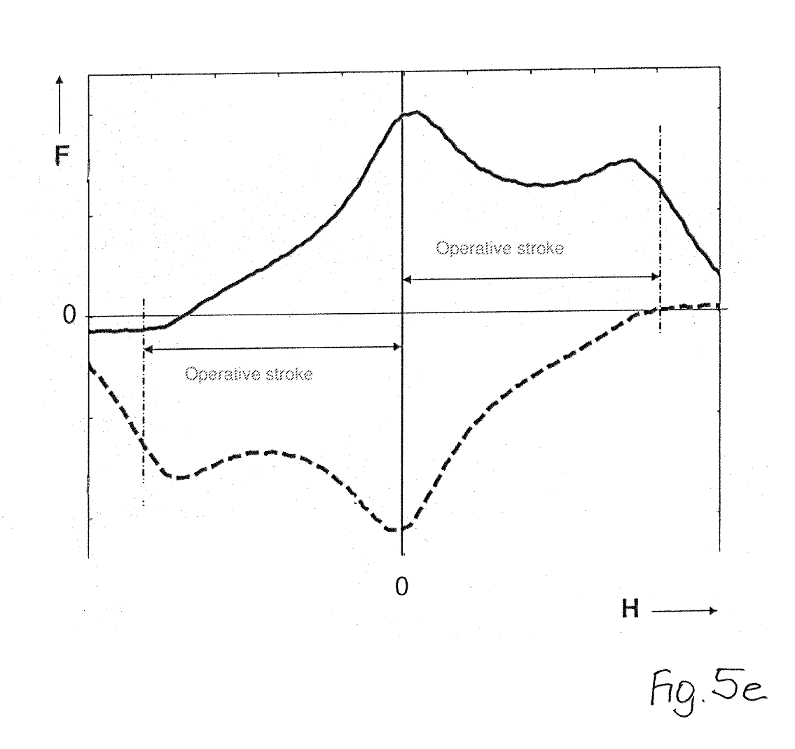

FIGS. 6a-c show an exemplary embodiment of the linear drive that is modified in comparison with the exemplary embodiment according to FIGS. 5a-d,

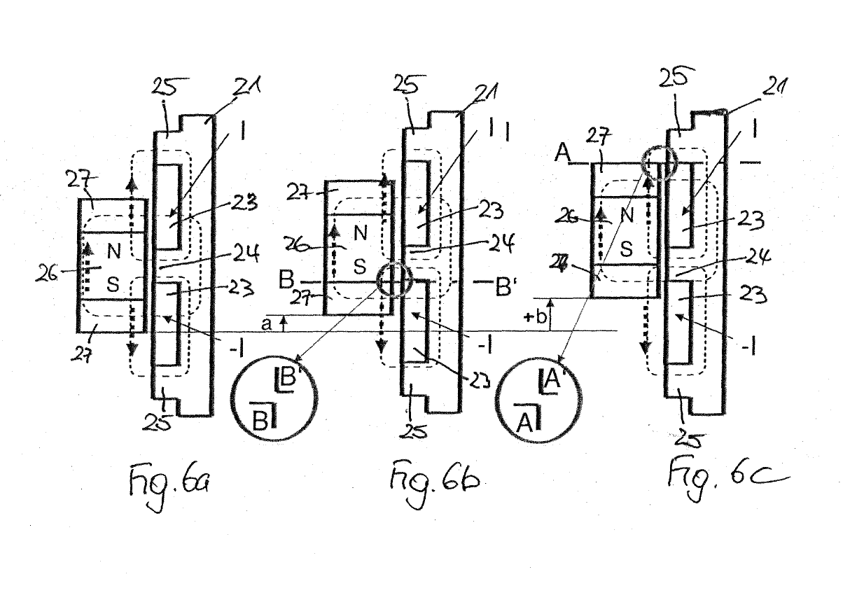

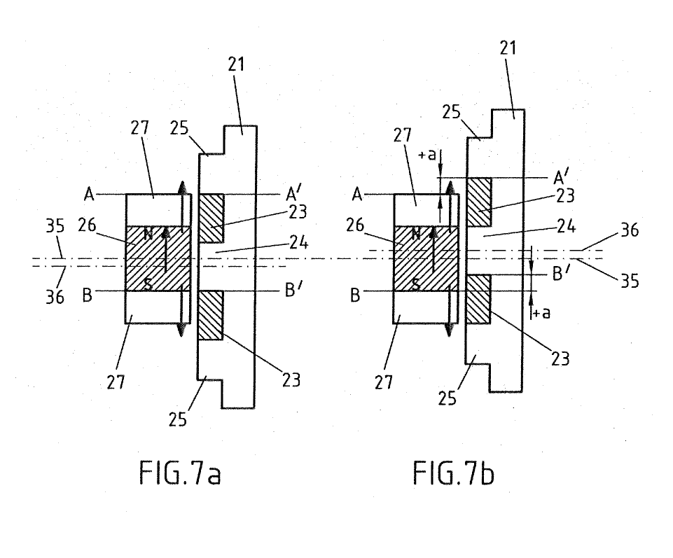

FIGS. 7a, b show a linear drive with an asymmetric design of the rotor and the stator,

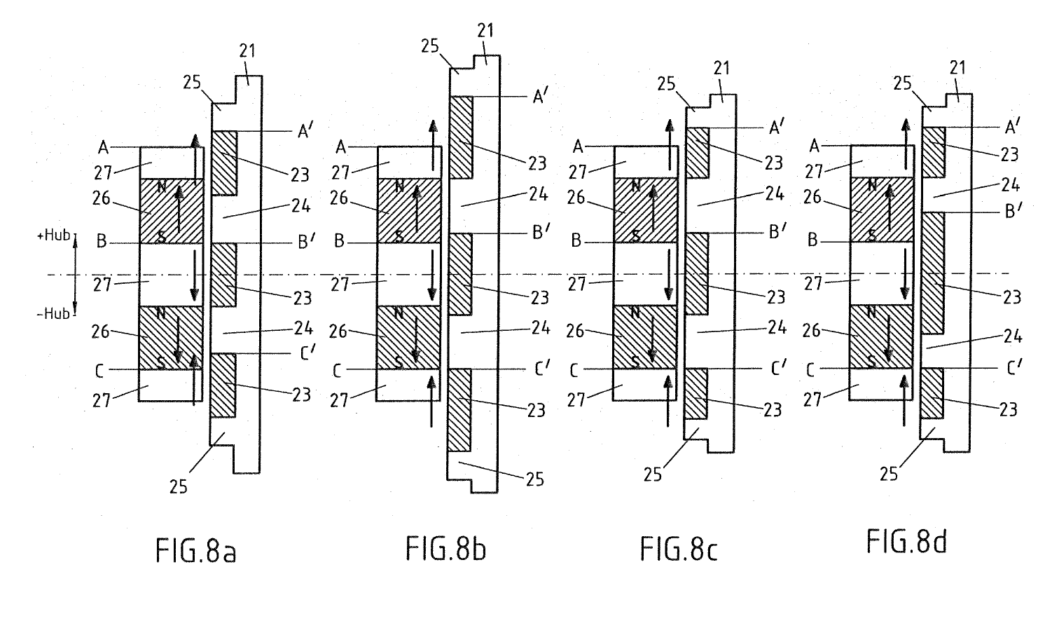

FIGS. 8a-d show other exemplary embodiments of linear drives with a stator that features three coils and a rotor that features two permanent magnets, and

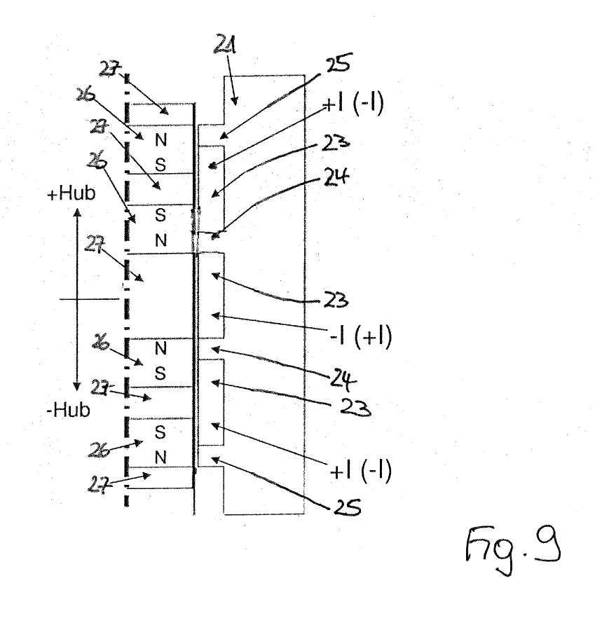

FIG. 9 shows another exemplary embodiment with a stator that features three coils and a rotor that features four permanent magnets with five pole pieces.

Although FIG. 1 shows the exemplary application of an inventive linear drive in a hydraulic valve, which is realized in the form of a directional control valve with a valve piston acting in both stroke directions, the detailed design of the hydraulic valve is not important. The exemplary valve housing 10 illustrated in FIG. 1 features four housing ports T-A-P-B, wherein a fifth port T situated adjacent to the port B is connected to the housing port T by means of a tank bridge 11 formed in the valve housing 10. The valve housing 10 contains a housing bore 12, in which a valve piston 13 is arranged in a longitudinally displaceable fashion. The valve piston 13 has two piston collars 14 that respectively shut the consumer ports A and B in the closed position of the valve piston shown in FIG. 1. On its two outer ends, the valve piston 13 respectively features a stepped extension 15 that is accommodated in a sealing sleeve 16 inserted into the housing bore 12 from outside. The corresponding end faces of the valve housing 10 are closed by means of externally attached housing covers 17 such that the sealing sleeves 16 are respectively fixed in the housing bore 12. In order to also adjust a defined starting position for the valve piston 13 without the assistance of a drive for the valve piston 13 that is described in greater detail further below, centring springs 18 act upon the valve piston 13 on both sides and thereby centre the valve piston 13 in its central position, which corresponds to the closed position of the valve in the exemplary embodiment shown.

In order to directly drive the valve piston 13, a housing-like stator 21 consisting of a magnetically conductive material is arranged on one side of the valve housing 10 and rigidly connected to the valve housing 10. A rotor 22 is arranged in the annular space enclosed by the stator 21 and connected to the assigned end of the valve piston 13 by means of a connecting rod 29 such that the linear motion of the rotor 22 is converted into a displacement of the valve piston 13 in the housing bore 12 of the valve housing 10.

In the exemplary linear drive 20 illustrated in FIG. 1, two coils 23 are arranged in the stator 21 and an inner web 24 is formed between said coils, wherein an outer web 25 is respectively formed on both outer sides of the two coils 23. The rotor 22 consists of a permanent magnet 26, on the two outer sides of which a pole piece 27 consisting of magnetically conductive material is respectively arranged. The rotor 22 is separated from the stator 21 by an air gap 28. The function of the exemplary linear drive illustrated in FIG. 1 is described in greater detail below with reference to the following figures.

FIGS. 2a-2f show a first exemplary embodiment of the inventive linear drive with a stator 21, which features a coil 23 with two outer webs 25, and a rotor 22, which consists of a permanent magnet 26 and two adjacent pole pieces 27, wherein the illustrated arrangement merely describes a valve stroke “a” referred to as working stroke in one direction.

According to FIG. 2a, the stator 21 features a coil 23 with respective outer webs 25; the rotor 22 consists of a permanent magnet 26 and two pole pieces 27 arranged adjacent thereto. In this case, the coil 23 has the same width as the pole piece 27 lying in the moving direction, wherein the starting position of the valve piston or the linear drive 20 is defined in that the rotor 22 is positioned in front of the coil 23 of the stator 21 with its pole piece 27 pointing in the moving direction. In this starting position, the corner of the pole piece 27 identified by the reference symbol “A” on the one hand and the adjacent corner of the outer web 25 referred to the coil 23, which as the associated corner is identified by the reference symbol “A′,” on the other hand are formed. These corners A, A′ fulfil the requirements that the corners A, A′ lie opposite of one another with the smallest transition surface and that the magnetic fields of the permanent magnet 26 and of the coil 23 energized with a positive current “I” are rectified and concentrated at this point in the air gap, wherein the latter is elucidated below with reference to FIGS. 2c-2e. In this context, FIG. 2c shows the field lines originating from the energized coil 23 without consideration of a field generated by the permanent magnet whereas FIG. 2d shows the field lines originating from the permanent magnet without consideration of a field generated by the coil current. FIG. 2e shows the concentration of the superimposed field lines of the permanent magnet 26 and of the energized coil 23 in the region of the corners A, A′, which ultimately leads to the desired force increase. With respect to the valve stroke to be carried out by the valve piston, this means that the rotor 22 moves out of its starting position with a correspondingly higher force and therefore drives the valve piston with the desired dynamic such that the counteracting flow forces and spring forces in the exemplary embodiment are overcome.

FIG. 2b furthermore shows that the front corner “B”′ of the pole piece 27 facing away from the motion of the rotor 22 once again encounters the lower corner “B” of the lower outer web 25 of the stator 21 after a stroke “a” has been reached, wherein the corresponding field lines are illustrated in their entirety in FIG. 2f. It can be gathered that the field concentration in the region of the corners B, B′, which results in a force increase, is solely caused by iron encountering iron because no coil current is involved. This means that the initial force, which diminishes over the course of the stroke, is once again increased after the stroke “a” has been reached such that the force-stroke characteristic corresponds to the characteristic occurring when a valve is opened. In this case, the stroke “a” may represent the end of the valve stroke; however, it is also possible that the overall valve stroke is greater than the stroke “a” such that the force increase is effective over the entire stroke of the valve piston.

When the rotor 22, as well as the valve piston 13 coupled thereto, should once again be returned into the starting position (FIG. 2a) after the valve stroke “a” has been reached, the rotor 22 may, after switching off the positive current “I,” either be returned into the starting position by only the spring acting upon the valve piston 13 (which corresponds to the centring spring 18 in the exemplary embodiment illustrated in FIG. 1) or by additionally energizing the coil 23 with a negative current such that the stroke direction of the rotor 22 is likewise reversed and its motion into the starting position is promoted, if applicable, by the provided spring.

In the exemplary embodiment illustrated in FIGS. 3a-d, the linear drive 20 has a symmetric design with respect to an axis of symmetry, which extends through the rotor 22 perpendicular to its moving direction in the starting position, such that the linear drive 20 illustrated in FIGS. 3a-d is designed for a directional control valve with a valve piston acting in both stroke directions. The stator 21 particularly features two coils 23 with an inner web 24 lying between said coils and two outer webs 25. The rotor once again consists of a permanent magnet 26 and two outer pole pieces 27. This exemplary embodiment is furthermore characterized in that the axial extent of the entire rotor 22 corresponds to the axial extent of the two coils 23 including the inner web 24, wherein the extent of the inner web 24 corresponds to the extent of the permanent magnet 26 and the extent of the coils 23 corresponds to the respective extent of the pole pieces 27.

According to the illustration in FIG. 3a, which corresponds to the illustration in FIG. 2a, respective corners A, A′ and B, B′ simultaneously lie opposite of one another at the two pole pieces 27 and the outer webs 25 in the starting position of the rotor 22 such that two cumulative force increases are effective when the coils 23 of the stator 21 are energized. For this purpose, the upper coil 23 lying in the moving direction of the rotor 22 is acted upon with a positive current +I such that the magnetic fields of the permanent magnet 26 and the upper coil 23 are rectified; the other, lower coil 23 is accordingly acted upon with a negative current −I. Consequently, a correspondingly high force is available for moving the valve piston out of its closed position and correspondingly high dynamics acts upon the valve piston. Since FIG. 3b shows that no additional force increase occurs in the region of the stroke “+a,” the correspondingly designed valve drive 20 can only be used in valves with a short stroke. Once the rotor 22 has returned into the starting position according to FIG. 3c after carrying out the stroke “+a,” the coils 23 are inversely energized by acting upon the lower coil 23 with the current +I and the upper coil 23 with the current −I. In this starting position of the rotor 22, respective corners C, C′ and D, D′ accordingly lie opposite of one another and thereby ensure an effective double force increase with respect to the stroke “−a” in the other moving direction of the valve piston as illustrated in FIG. 3d when the coils are energized. In this context, FIG. 3e shows the corresponding force-stroke diagram with the stroke characteristic when the valve is respectively opened or closed in the two valve directions.

The valve illustrated in FIGS. 4a-c can be distinguished from the above-described valve in that, although the extents of the rotor 22 on the one hand and of the coils 23 with the inner web 24 on the other hand are still identical, the extent of the coils 23 is now greater than the extent of the pole pieces 27 such that the extent of the inner web 24 is smaller than the extent of the permanent magnet 26. In the starting position of the rotor 22 illustrated in FIG. 4a, the corners A, A′, which respectively lie opposite of one another in the region of the upper pole piece 27 and the upper outer web 25, consequently cause an effective force increase at the beginning of the stroke when the coils are energized whereas the corners B, B′ of the lower pole piece 27 and inner web 24 are moved into the relative position causing a corresponding force increase after a short stroke “a” such that an additional force increase is now realized over the entire stroke of the rotor 22. According to a comparison of FIG. 4c with FIG. 3e, this broadens the desired force progression over the entire operative stroke “a” such that a thusly designed linear drive 20 can also be used for valves with a somewhat greater stroke.

In the exemplary embodiment of a linear drive 20 illustrated in FIGS. 5a-d, the extent of the two coils 23 with the inner web 24 of the stator 21 is greater than the extent of the rotor 22 with the permanent magnet 26 and the pole pieces 27 such that the two outer webs 25 of the stator 21 are shifted farther outward in the starting position of the rotor 22. In correspondence with the exemplary embodiment described with reference to FIGS. 3a-d, however, the extent of the inner web 24 still corresponds to the extent of the permanent magnet 26. In the starting position of the rotor 22 according to FIG. 5a, the corner B of the pole piece 27 facing away from the moving direction of the rotor 22 on the permanent magnet side consequently is positioned in front of the corner B′ of the inner web 24 facing the lower coil 23 such that a force increase occurs in this starting position when the coils 23 are energized. In this case, the upper coil 23 is once again acted upon with a current +I and the lower coil is acted upon with a current −I. Once the rotor 22 has reached a stroke “+a” as illustrated in FIG. 5b, the front corner A of the front pole piece 27 referred to the moving direction is positioned in front of the coil-side corner A′ of the outer web 25 of the stator 21 lying in the moving direction of the rotor such that another effective increase of the force, which has already diminished over the stroke “+a,” is realized upon reaching the stroke “+a.”

This also applies accordingly to the stroke “−a” in the other moving direction, wherein the corners C, C′ of the pole piece 27 and the inner web 24 are positioned in front of one another in the starting position of the rotor 22 illustrated in FIG. 5c and the corners D, D′ of the pole piece 27 and the outer web 25 are positioned in front of one another when the stroke “−a” is reached in order to respectively realize a force increase. FIG. 5e shows the corresponding force-stroke characteristic over the operative stroke, according to which a sufficient force level is also made available for valves with a longer stroke.

The exemplary embodiment illustrated in FIGS. 6a-c is also particularly suitable for valves with a long valve stroke. In contrast to the exemplary embodiment described with reference to FIGS. 5a-d, the extent of the inner web 24 is dimensioned smaller than the extent of the permanent magnet 26 of the rotor 22, but all other specifications are identical. As a result, no force increase can be registered in the starting position of the rotor 22 illustrated in FIG. 6a because no relevant corners of webs and pole pieces lie opposite of one another. However, once the rotor 22 has reached a short initial stroke “+a” as illustrated in FIG. 6b, the corner B of the lower pole piece 27 and the lower corner B′ of the inner web 24 are positioned opposite of one another such that a first force increase occurs at this time. During the further stroke of the rotor 22 in the long-stroke valve as illustrated in FIG. 6c, the corner A of the upper pole piece 27 is moved in front of the coil-side corner A′ of the upper outer web 25 of the stator 21 such that another force increase occurs when the stroke “+b” is reached. In this way, a sufficient force level can also be made available over a longer valve stroke.

In the exemplary embodiments of the linear drive 20 described above with reference to FIGS. 3-6, the rotor 22 and the stator 21 respectively have a symmetric design such that the corresponding linear drives are suitable for use in directional control valves as described above. However, if an asymmetric arrangement of pole pieces and/or inner and outer webs is chosen in the design of the rotor and/or the stator, corresponding force increases only occur in one moving direction of the rotor such that linear drives 20 of this type are suitable for use in plug-in valves, in which only one moving direction of the valve piston is relevant.

A corresponding example is respectively illustrated in FIGS. 7a and 7b. In FIG. 7a, the centre line 35 of the rotor 22 extending through the permanent magnet 26 is offset by a certain amount relative to the centre line 36 of the stator 21 extending through the inner web 24 in the moving direction of the rotor 22 such that a force increase is in accordance with the preceding detailed explanations already realized in the starting position of the rotor 22 when the coils 23 of the stator 21 are energized accordingly. In the exemplary embodiment illustrated in FIG. 7b, in contrast, the centre line 36 of the stator 21 is offset by a certain amount relative to the centre line 35 of the rotor 22 in the moving direction of the rotor 22 such that a corresponding force increase is in this case realized after the stroke “+a” has been reached.

Based on the above-described exemplary embodiments, the inventive design can also be realized with a greater number of coils 23 and inner webs 24 formed thereby on the one hand and/or with a greater number of permanent magnets 26 and pole pieces 27 on the other hand. The axial extents of pole pieces and/or permanent magnets 26, as well as of inner webs 24 and outer webs 25 predefined by the length of the coils 23 in the stator 21, may vary in this case. If two corners of the rotor 22 and the stator 21 respectively are simultaneously positioned in front of one another in different positions, a force increase occurs in the respective position of the rotor and the valve piston connected thereto whereas an increase of the stroke with a sufficiently high expenditure of force occurs if two corners of the rotor and the stator respectively are successively positioned in front of one another over the respective stroke of the rotor 22 or the valve piston.

These circumstances are elucidated below with reference to the exemplary embodiments schematically illustrated in FIGS. 8a-d. In this case, three coils 23 are respectively arranged in the stator 21 such that two inner webs 24 and the two outer webs 25 are provided. The individual exemplary embodiments according to FIGS. 8a-d differ with respect to the extent of the respective webs 24, 25, but the design of the rotor 22 with two permanent magnets 26, an inner pole piece 27 and two outer pole pieces 27 remains the same. Such a design also makes it possible to achieve sufficient force levels over a longer valve stroke because a force increase is not only realized in the starting position of the rotor 22 due to the respectively opposing corners of pole pieces 27 and webs 24, 25 along the line B-B′ in FIG. 8a and along the line C-C′ in FIGS. 8b-d, but two additional force increases also become effective over the stroke of the rotor 22, namely along the lines C-C′ and A-A′ in FIG. 8a and along the lines B-B′ and A-A′ in FIGS. 8b-d. According to the inventive principle, it goes without saying that the extent of the permanent magnets 26 and of the associated pole pieces 27 can also be modified. In this respect, the specific design of the components of the rotor 22 and the stator 21 depends on the respective forces that counteract the stroke of the valve piston and need to be overcome.

FIG. 9 ultimately shows an exemplary embodiment of a design of the rotor 22 that is expanded in comparison with the exemplary embodiments according to FIGS. 8a-d. Although the stator 21 still comprises three coils 23, the rotor 22 now features four permanent magnets 26 and consequently five pole pieces 27, wherein the width of the pole pieces 27 respectively decreases outward starting with the innermost central pole piece 27. Several successive force increases also occur in this case during the displacement of the rotor 22 relative to the stator 21. Although FIG. 9 respectively shows a symmetric design of the rotor 22 and the stator 21 such that this linear drive 20 is suitable for use in a directional control valve, a linear drive of this type also can be easily modified for use in a plug-in valve, for example, by omitting the bottom outer pole piece 27 in the direction of the stroke “+a” such that the rotor has an asymmetric design.

The characteristics of the object of these documents disclosed in the preceding description, the claims, the abstract and the drawings may be essential to the realization of the different embodiments of the invention individually, as well as in arbitrary combinations.

1. A valve with a valve piston that can be moved linearly in a valve housing and a linear drive comprising a stator, which is immovably connected to the valve housing, and a rotor, which can be moved therein and acts upon the valve piston, wherein the stator is composed of a housing consisting of magnetically conductive material and at least one coil arranged therein, and wherein the rotor, which is separated from the stator by an air gap, consists of at least one permanent magnet with pole pieces that consist of magnetically conductive material and border on the respective pole of the permanent magnet, characterized in that, if a coil s embedded in the stator housing, an outer web is respectively arranged on their outer sides or, if multiple coils are embedded in the stator housing, an inner web is respectively arranged between the coils and an associated outer web is respectively arranged on the outer sides of the outermost coils, wherein the axial extents of inner webs and outer webs, permanent magnets and pole pieces are adapted to one another in such a way that, in order to realize an effective force increase when at least one coil is energized, at least one corner (A, B) (C, D) of a pole piece on the one hand and at least one corner (A′, B′) (C′, D′) of an outer web on the other hand lie opposite of one another in the stroke region of the valve piston in such a way that the magnetic fields of the permanent magnet and the energized coil are rectified and concentrated at this point in the air gap.

2. The valve according to claim 1, wherein the rotor is composed of at least two permanent magnets and at least three pole pieces, wherein a coil is assigned to at least one pole piece of the rotor in the stator.

3. The valve according to claim 1, wherein the distances between the webs arranged in the stator are respectively identical and the axial extents of the pole pieces in the rotor differ from one another.

4. The valve according to claim 1, wherein the distances between the webs arranged in the stator differ from one another and the axial extents of all pole pieces in the rotor are respectively identical.

5. The valve according to claim 1, wherein the distances between the webs arranged in the stator, as well as the axial extents of the pole pieces in the rotor, respectively differ from one another.

6. The valve according to claim 1, wherein the distances between the webs arranged in the stator, as well as the axial extents of the pole pieces in the rotor, are respectively identical to one another.

7. The valve according to claim 1, wherein the rotor and the stator have a symmetric design referred to the axis of symmetry extending perpendicular to the moving direction of the rotor if the valve is realized in the form of a directional control valve with a valve piston acting in both stroke directions.

8. The valve according to claim 1, wherein the rotor and the stator have an asymmetric design referred to the axis of symmetry extending perpendicular to the moving direction of the rotor if the valve is realized in the form of a plug-in valve with a valve piston acting in one stroke direction only.

9. The valve according to claim 1, wherein multiple linear drives, which respectively consist of a stator and a rotor and the rotors of which are connected to the valve piston, are arranged parallel to one another in order to increase the force in the moving direction of the valve piston.

10. The valve according to claim 1, wherein means are provided for automatically adjusting a starting position of the rotor, which is connected to the valve piston, in the deenergized state of the linear drive.

11. The valve according to claim 10, wherein the means for automatically adjusting the starting position of the rotor consist of centring springs, which act upon the valve piston on both sides.

12. The valve according to claim 1, wherein the starting position of the valve piston corresponds to the closed position of the valve.

13. The valve according to claim 1, wherein the starting position of the rotor corresponds to a working position of the valve piston, in which connections between valve housing ports are maintained open.
